(19) United States
(12) Patent Application Publication
(10) Pub. No.: US 2015/0021054 A1
(43) Pub. Date: Jan. 22, 2015

(54) AUTOMATIC FIRE TARGETING AND EXTINGUISHING SYSTEM AND METHOD

(71) Applicants: Ian Edward McNamara, Elgin, IL (US); Nathan Lindstrom Rapp, Naperville, IL (US); Nicholas Joseph Toombs, Monticello, IL (US); Joshua Kim, Urbana, IL (US)

(72) Inventors: Ian Edward McNamara, Elgin, IL (US); Nathan Lindstrom Rapp, Naperville, IL (US); Nicholas Joseph Toombs, Monticello, IL (US); Joshua Kim, Urbana, IL (US)

(21) Appl. No.: 13/946,696

(22) Filed: Jul. 19, 2013

(51) Int. Cl. A62C 37/36; G05D 16/20; G05B 19/048

(52) U.S. Cl. CPC A62C 37/04; A62C 37/36; G05B 19/048; G05D 16/20; G05B 2219/24015
USPC 169/46; 169/61

(57) ABSTRACT

A system for providing an automatic fire extinguishing system including a tank filled with an extinguishing agent with a targeting system with independently mounted targeting servos and targeting gimbal to position an emitter. A microcontroller provides control signals to the targeting servos and an actuation valve. A plurality of temperature sensors electrically connected to the microcontroller send temperature data to the microcontroller which calculates target angles and sends the target angle to the targeting gimbal. The emitter is positioned by the targeting servo positioning the targeting gimbal armatures to the target angles. The microcontroller compares sensor temperature data a predetermined temperature value and sends an open signal to the actuation valve when a sensor temperature data is greater than the predetermined temperature value. The extinguishing agent flows from the tank to the emitter, where it is discharged.

### BACKGROUND OF THE INVENTION

The present invention relates to an automatic fire targeting and extinguishing system and method.

There are a myriad of fire extinguishing systems that are well known in the art. Most predominantly is the self-contained portable fire extinguisher. The portable fire extinguisher has an extinguishing agent in a sealed tank that is either pressurized or has a pressurization source connected. The user arms the portable fire extinguisher and discharges the extinguishing agent on the fire. The portable fire extinguisher has several drawbacks. First and most importantly, someone must be present at the fire location to find the fire and the portable extinguisher must be accessible to the person finding the fire. Second, the user must be in close proximity to the fire to discharge the extinguishing agent with any effectiveness, usually less than 10 feet, this puts the user in significant danger. The larger the size and more developed the fire has become the more dangerous the use of a portable extinguisher becomes. Further, the portable fire extinguisher has a limited capacity, usually 30-45 seconds of discharge. This limited capacity may be sufficient for small fires that are detected quickly after initiation, but has virtually no effect for more developed fires. Another drawback of the portable extinguisher is the extinguishing agent may be for a specific class of fire and not suitable, for extinguishing the detected fire, without increased risk to the user.

Another prior at firefighting system is a sprinkler system. Sprinkler systems have a series of sprinkler heads connected to a water main. The water main supplies a continuous application of extinguishing agent, water, to the fire. The sprinkler systems are typically actuated by the melting of a fusible link or breaking of a glass bulb, at a predetermined temperature. The fusible link or glass bulb hold a plug in place against the pressure of the water main. When the fusible link melts or the glass bulb breaks, the plug is forced out of the way and the extinguishing agent is discharged in the area under the sprinkler head. In some systems, discharging from one sprinkler head activates the other sprinkler heads in the building, floor, or a sector. The drawback of the sprinkler system is the continuous application of extinguishing agent, such as water, does not stop until the water main is isolated from the sprinkler system. This continuous discharge results in hundreds of gallons of water being discharged into the space. Further, in systems where the initiation of one sprinkler head activates other sprinkler heads, unaffected areas are subjected to the significant water release. The damage done to property from the discharged water is much more than from the fire, and includes flooding of unaffected areas and the floors below.

Another prior art fire fighting system is the self-contained area sprinkler system. These systems utilize a pressured tank of extinguishing agent suspended in the overhead. The extinguishing agent is connected to a sprinkler head similar to those used in standard sprinkler systems. When the self-contained sprinkler system is activated it discharges the extinguishing agent in the area below and around the sprinkler head until the tank is exhausted. The drawback to the self-contained sprinkler system is the agent is not directed to a specific area, but is discharged over a general area, limiting the effectiveness of the extinguishing agent.

Clean agent fire suppression systems are commonly used in areas with sensitive or expensive equipment. The clean agent fire suppression systems use a heavy gas such as Halon to displace oxygen, smothering the fire. The system is typically electronically activated by temperature sensors, or activated by fusible links, or manually initiated. The gas dissipates quickly after the discharge is complete and ventilation is restored, and causes no damage to the space or equipment. The drawback to these systems is the danger to personnel, because any person in the space during or immediately after the discharge will asphyxiate without breathing protection.

U.S. Pat. No. 4,671,362 to Odashima teaches an automatic fire extinguisher with infrared ray responsive type fire detector. In an embodiment of the automatic fire extinguisher it includes a rotatable ejection emitter, which isposition the diametric opening to the angle corresponding to a fire in a 360° range and position the emitter body to a 90° range. This embodiment requires separate servo and gearing to accommodate the positioning the diametric opening and emitter body. Further, this embodiment is limited to infrared fire detection.

U.S. Pat. No. 3,588,893 to Closkey teaches an apparatus for detecting and locating a fire and producing at least one intelligence-carrying output signal. In an embodiment of the apparatus has a rotatable shaft on a master synchro driven through spur reduction gears by a master servo and a slave rotor and synchro to position the emitter to a the angle of the detected fire. This embodiment requires multiple gears and dependent targeting synchros to position the emitter.

U.S. Pat. No. 5,548,276 to Thomas teaches a localized automatic fire extinguishing apparatus. In an embodiment the apparatus has motorized turret which is rotatable on a vertical axis by a motor terminating in a gear attached to a ring gear attached to the turret, and a motorized emitter arm driven by a motor attached to a toothed wheel which engages a gear to position the arm. This embodiment requires multiple gears to position the emitter.

The prior art has failed to supply a simple fire suppression system that maximizes the effectiveness of the extinguishing agent minimizes the risk to personnel and property, and maximizes reliability.

### BRIEF SUMMARY OF THE INVENTION

One or more of the embodiments of the present invention provide an automatic fire extinguishing system including a tank filled with an extinguishing agent with a targeting system with independently mounted targeting servos and targeting armatures to position a emitter. A microcontroller provides control signals to the targeting servos and actuation valve. A plurality of temperature sensors electrically connected to the microcontroller send temperature data to the microcontroller which calculates target angles and sends the target angle to the targeting servos. The emitter is positioned by the targeting servos positioning the targeting armatures to the target angles. The microcontroller compares sensor temperature data to a predetermined temperature value and sends an open signal to the actuation valve when a sensor temperature data is greater than the predetermined temperature value. The extinguishing agent flows from the tank to the emitter, discharging the extinguishing agent.

### BRIEF DESCRIPTION OF THE DRAWINGS

FIG. 1 illustrates an exploded view of an extinguishing agent emission system 100 according to an embodiment of the present invention.

FIG. 2 illustrates a schematic representation of an automatic fire targeting and extinguishing system according to an embodiment of the present invention.

FIG. 3 illustrates an exploded view of an embodiment of the gimbal targeting system according to an embodiment of the present invention.

FIG. 4 illustrates a block diagram of the control circuit according to an embodiment of the present invention.

FIG. 5 illustrates a flow chart of the monitoring mode according to an embodiment of the present invention.

FIG. 6 illustrates a flowchart of the active mode according to an embodiment of the present invention.

FIG. 7 illustrates a flow chart of the alert routine according to an embodiment of the present invention.

FIG. 8 illustrates a flowchart of the mode and actuation programming according to an embodiment of the present invention.

FIG. 9 illustrates a flowchart of programming targeting values according to an embodiment of the present invention.

FIG. 10 illustrates an overhead view of a sensor grid according to an embodiment of the present invention.

FIG. 11 illustrates the calculation of targeting angles according to an embodiment of the present invention.

FIG. 12 illustrates an assembled view of an extinguishing agent emission system. The extinguishing agent emission system is the same as the extinguishing agent emission system of FIG. 1, but assembled for context.

FIG. 13 illustrates an assembled view of a targeting gimbal. The targeting gimbal is the same as the targeting gimbal of FIG. 3, but assembled for context.

### DETAILED DESCRIPTION OF THE INVENTION

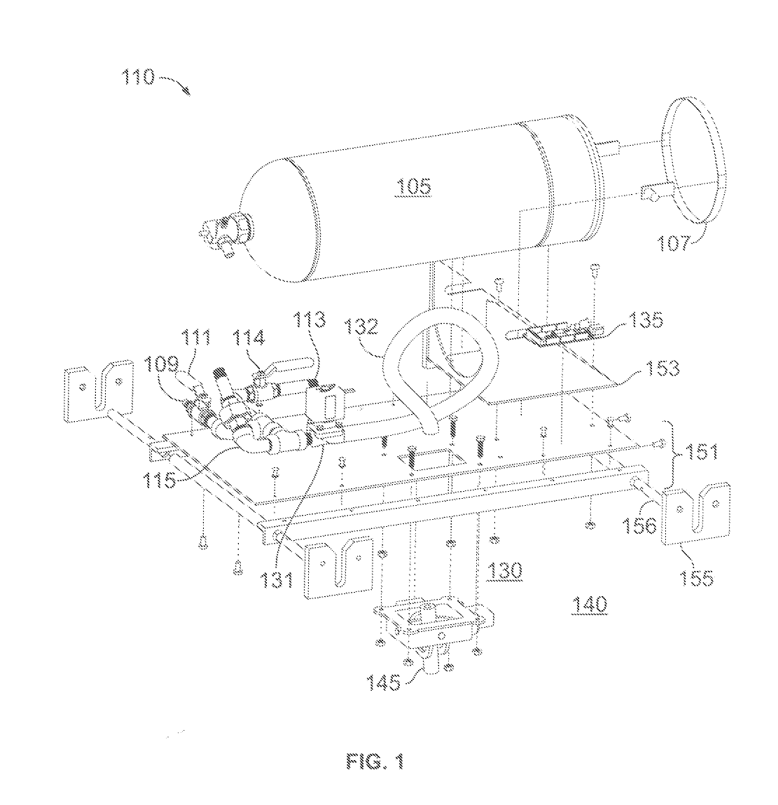

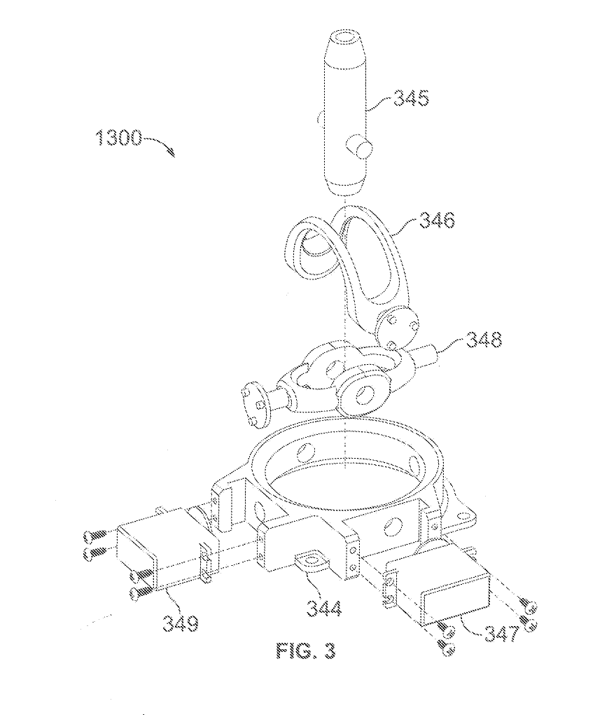

FIG. 1 illustrates an extinguishing agent emission system 100 according to an embodiment of the present invention. The extinguishing agent emission system 100 includes an agent storage system 110, an actuation system 130, a targeting system 140, and a support unit 150. The agent storage system 110 includes a pressure tank 105, a retention strap 107, a charging port 109, a charging port valve 111, a sprinkler head 113, a sprinkler head isolation valve 114, and pressurized piping 115. The actuation system 130 includes an actuation valve 131, and flexible piping 132. The targeting system 140 includes a control circuit 135 and an emitter 145. The targeting system 140 also includes a gimbal base 344, a first targeting armature 346, a first targeting servo 347, a second targeting armature 348, and a second targeting servo 349 illustrated in FIG. 3. The support unit 150 includes a foundation 151, support pins 156, mounting brackets 155, and a tank support bracket 153.

The mounting brackets 155, of the support unit 150 are in physical connection with the structure to which the unit is to be mounted. The support pins 156 are in physical connection with the mounting brackets 155. The support pins are in physical connection with the foundation 151. The foundation is in physical connection with the tank support bracket 153. The retention strap 107 is in physical connection with the tank support bracket 153. The pressure tank 105 is in physical connection with the retention strap 107. The pressurized piping 115 is in physical connection with the foundation 151. The gimbal base 344 is in physical connection with the foundation 344. The first targeting servo 347 is physically connected to the gimbal base 344 and the first targeting armature. The second targeting servo 349 is in physical connection with the gimbal base 344 and the second targeting armature 348. The emitter 345 is in physical connection with the first targeting armature 346 and the second targeting armature 348.

The pressure tank 105 is in pneumatic connection with the pressure piping 115. The pressure piping 115 is in pneumatic connection with the actuation valve 131, the sprinkler head isolation valve 114, and the charging port valve 111. The charging port valve 111 is in pneumatic connection with the pressure tank 105 and the charging port 109. The actuation valve 131 is in pneumatic connection with the flexible piping 132. The flexible piping is in pneumatic connection with the emitter 145. The sprinkler head isolation valve 114 is in pneumatic connection with the sprinkler head 113.

The control circuit 135 is in electrical connection with the actuation valve 131, first targeting servo 347 and the second targeting servo 349.

In operation, the pressure tank 105 is filled with a predetermined amount of extinguishing agent. In the preferred embodiment the extinguishing agent is monoammonium phosphate. Other acceptable agents depending on the application, include but are not limited to, water, aqueous film forming foam, carbon dioxide, and Purple K. The pressure tank 105 has an internal feeding tube which draws from the bottom of the tank or a port disposed as low as possible on the tank to utilize the maximum amount of extinguishing agent, due to the pressure tank being horizontally mounted. The pressure tank 105 is secured on to the foundation 151 by the tank support bracket 153 and retention strap 107. The pressure piping 115 is connected to the pressure tank 105. The sprinkler head isolation valve 114 is shut during pressurization, to prevent damage to the sprinkler head 113. The pressure tank 105 is pressurized by compressed gas including, but not limited to air, nitrogen or carbon dioxide to a predetermined value by connecting a high pressure source to the charging port 109 and opening the charging port valve 111, allowing the pressurized air to flow through the pressure piping 115 to the pressure tank. When the pressure tank 105 has reached the predetermined pressure the charging port valve 111 is shut and the high pressure source is removed from the charging port 109. The sprinkler head isolation valve 114 is opened slowly, controlling the pressure transient on the sprinkler head 113, until full pressure is placed on the sprinkler head

Mounting brackets 155 are placed at predetermined locations on the mounting structure. The support pins 156 are placed onto the mounting brackets supporting the weight of the extinguishing agent emission system 100. In the preferred embodiment the support pins 156 are retractable and held in position by set screws, but is stationary.

In automatic operation, the control circuit 135 and sends electronic control signals to the first and second targeting servos 347, 349 as illustrated in FIG. 3. The first and second targeting servos 347, 349 position the first and second targeting armatures 346, 348 to direct the emitter 145 toward the fire. When the emitter 145 is in position the control circuit sends an electronic signal to the actuation valve 131 to open. The pressurized fire extinguishing agent flows from the pressure tank 105 through the pressure piping 115, through the actuation valve 131, through the flexible piping 132, to the emitter 145. The emitter 145 discharges the agent onto the fire until the control circuit 135 determines that the fire is extinguished or the pressure tank 105 is exhausted. When the control circuit 135 senses the fire has been extinguished, the control circuit sends an electronic signal to shut the actuation valve 131. If the fire rekindles the control circuit 135 recommences the targeting and extinguishing routine, until the pressure tank is exhausted.

In backup operation, the sprinkler head 113 has a glass bulb or fusible link. The fusible link or glass bulb hold a plug in place preventing discharge. The fusible link or bulb break or melt at a predetermine temperature. In the preferred embodiment the link melts at 145° F., but can be made for any temperature, depending on application. When the bulb or fusible links are actuated by temperature the system pressure pushes the plug out. The extinguishing agent flows from the pressure tank 105 through the pressure piping 115, through the sprinkler head isolation valve 114 to the sprinkler head 113. The sprinkler head 113 discharges the extinguishing agent over a predetermined area until the pressure tank 105 is exhausted.

In an alternative embodiment the pressure tank 105 is a series of tanks. The pressure tanks 105 are pneumatically connected to the pressure piping 115 in parallel to increase the capacity of the system. Additionally, blow out valves and check valves are placed between the tanks to maintain pressure. As the first pressure tank 105 in the series pressure drops below a predetermined pressure the blowout valve opens to a second pressure tank. When the pressure of the first pressure tank 105 drops below a second predetermine pressure a check valve will close seal the first pressure tank.

In an alternative embodiment, the extinguishing agent is a water supply, such as, a buildings water piping. The water supply is normally under pressure and replaces the pressurized tank. The water supply is hydraulically connected to the actuation valve 131. The operation of the actuation and targeting are the same.

In the preferred embodiment the pressure piping is cross-linked polyurethane or PEX tubing. PEX tubing is ideal for high and low temperature and pressure applications. The pressure piping is made of any material that is suitable for the pressure and temperatures conditions of the application, such as copper or steel.

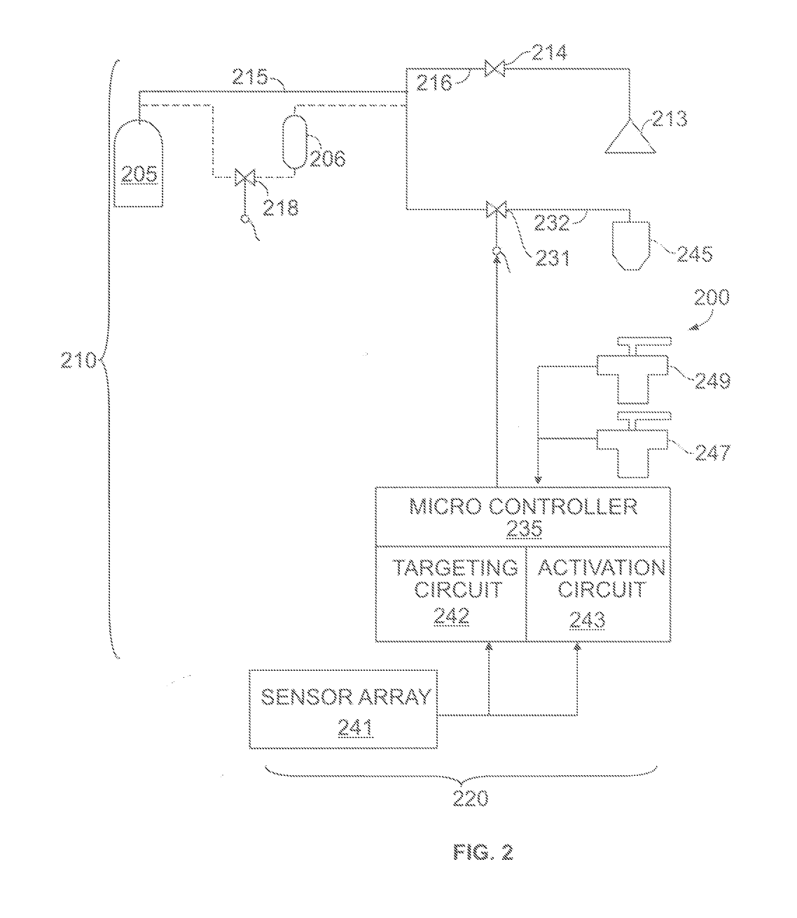

FIG. 2 illustrates a schematic representation of an automatic fire targeting and extinguishing system 200 according to an embodiment of the present invention. The automatic fire targeting and extinguishing system includes an extinguishing agent emission system 210 and a directional temperature sensor system 220. The extinguishing agent emission system includes a pressure tank 205, pressure piping 215, a sprinkler head supply piping 216, a sprinkler head isolation valve 214, a sprinkler head 213, an actuation valve 231, actuation circuit 243 including a microcontroller 235, a flexible tubing 232, a emitter, and targeting servos 247, 249. The directional temperature sensor system 220 includes a targeting circuit 242 including the microcontroller 235, and a sensor grid 241.

The pressure tank 205, of the extinguishing agent emission system 210, is in pneumatic connection with the pressure piping 215. The Pressure piping 215 is in pneumatic connection with the sprinkler head supply piping 216, and the actuation valve 231. The sprinkler head supply piping 216, is in pneumatic connection with the sprinkler head isolation valve 214. The sprinkler head isolation valve 214 is in pneumatic connection with the sprinkler head 213. The actuation valve 231 is in pneumatic connection with the flexible tubing 232, of the actuation system 230. The flexible tubing 232 is in pneumatic connection with the emitter 245.

The sensor grid 241, directional temperature sensor system 220, is in electrical communication with the actuation circuit 242 and targeting circuit 243 of the control circuit 235. The Actuation circuit 242 is in electrical communication with the actuation valve 231. The targeting circuit 243 is in electrical communication with the targeting servos 247, 249.

In one embodiment the sensor grid 241 includes nine thermistors placed in a grid pattern in the overhead of the room in the system is used in. In one embodiment, thermistors have a functional range of −40° F. to 257° F. which is desirable for an actuation setting prior to the room becoming engulfed in flames. In applications where the temperatures are higher or actuation is not desirable at an early stage of a fire, such as a progressive extinguishing system thermocouples may be utilized. The preferred embodiment is designed for an 8×8×8 foot room, but number of thermistors is adjusted to accommodate larger or smaller rooms. The thermistors of the sensor grid 241 send a continuous electronic signal proportional to the temperature in the monitored zone. The control circuit monitors for temperatures exceeding a predetermined value or a predetermined temperature rate increase. In the preferred embodiment the actuation temperature is 140° F. and the actuation rate is 3.6° F. over 10 seconds. The actuation temperature may be adjusted to accommodate the application. When the control circuit 235 senses an actuation value from the sensor grid 241, the targeting circuit 243, of the control circuit, sends an electronic control signal to the targeting servos 247, 249 to position the emitter 245 toward the elevated heat position. The targeting servos 247, 249 send a feedback signal to the targeting circuit to indicate the current position. When the current position of the 247, 249 matches the elevated heat or target position the targeting circuit 243 sends a signal to the actuation circuit 242. When the actuation circuit 243 receives the position match signal from the targeting circuit 243, the actuation circuit sends an open signal to the actuation valve 231. In response to the open signal the actuation valve opens. When the actuation valve 231 opens, the extinguishing agent flows from the pressure tank 205 through the pressure piping 215, through the open actuation valve 231, through the flexible tubing 232 to the emitter 245. The emitter 245 discharges the extinguishing agent onto the fire. The extinguishing agent continues to be discharged onto the fire until the pressure tank 205 is exhausted or the sensor grid 241 senses a stop condition.

When the thermistors of the sensor grid 241 senses that the temperature has decreased below a predetermined value and/or rate the actuation circuit 232 sends a shut signal to the actuation valve 231. In response the shut signal the actuation valve shuts, stopping the flow of extinguishing agent. The control circuit 235 continues monitoring and recommences the extinguishing routine if an actuation value is again reached.

In backup operation, the extinguishing agent is prevented from flowing through the sprinkler head 213 by a plug, held in place by a fusible link or glass bulb. When the fusible link or glass bulb reach a predetermined temperature the fusible link melts or the glass bulb breaks, releasing the plug. The plug is pushed out of the sprinkler head by the pressure of the extinguishing agent. When the plug has been discharged the extinguishing agent flows from the pressure tank 205 through the pressure piping 215, through the sprinkler head supply piping 216, through the sprinkler head isolation valve 214, to the sprinkler head 213. The sprinkler head discharges and disperses the extinguishing agent into the area below until the pressure tank 205 is exhausted.

In an alternative embodiment, the system is designed for extinguishing agents that have adverse effects under continuous pressure, such as caking of powdered agents. In this embodiment, the system includes an extinguishing agent tank 206, a pressure tank 205 and a second actuation valve 218. The extinguishing agent tank 206 being in pneumatic connection with the first actuation valve 231 and the second actuation valve 218. The second actuation valve is in pneumatic connection with the pressure tank 205. This embodiment requires a control signal to pressurize the extinguishing agent; therefore the backup sprinkler head 213 and sprinkler head isolation valve 214 are removed from the system. When the control circuit 235 sends the open signal, the open signal is received by the first actuation valve 231 and the second actuation valve 210. The pressurized air flows though the pressure piping 215 through the second actuation valve 218, to the extinguishing agent tank 206, through the second actuation valve 231 through the flexible piping 232 to the emitter 245. The emitter 245 discharges the extinguishing agent onto the fire.

FIG. 3 illustrates an embodiment of the gimbal targeting system 300 according to an embodiment of the present invention. The gimbal targeting system 300 includes a gimbal base 344, a emitter 345, a first targeting armature 346, a second targeting armature 348, a first targeting servo 347, and a second targeting servo 349.

The gimbal base 344, of the gimbal targeting system is in physical connection to the foundation 151, of the support unit 150, illustrated in FIG. 1. The first targeting servo 347 is physically connected to the gimbal base 344 and the first targeting armature 346. The second targeting servo 349 is physically connected to the gimbal base 344 and the second targeting armature 348. The first targeting armature 346 is pivotally connected to the gimbal base 344 by shafts extending through the gimbal base. The second targeting armature 348 is pivotally connected to the gimbal base 344 by shafts extending through the gimbal base. The emitter is pivotally connected to the second targeting armature by a pair of pivot shafts extending from the emitter through the second targeting armature. The emitter 345 passes through the first and second targeting armatures 346, 348.

In operation, the first targeting servo 347 and second targeting servo 349 may function simultaneously. When the first targeting armature receives a control signal from the targeting circuit 243, the first targeting servo 347 moves the first targeting armature 346 to the targeting position received from the targeting circuit 243. The first targeting armature 346 pivots the emitter 345 on the shafts extending into the second targeting armature 348 to place the emitter at the appropriate angle on an x-axis. When the second targeting servo 349 receives a control signal, the second targeting servo positions the second targeting armature 348 to the targeting position received from the targeting circuit 243. The emitter 345 is positioned by the second targeting armature by physical connection though the shafts extending into the second targeting armature, to an appropriate target position on a y-axis. The targeting circuit 243 monitors the position of the servos by electronic feedback signal.

FIG. 4 illustrates a block diagram of the control circuit 400 according to an embodiment of the present invention. The control circuit 400 includes a microcontroller 435, a first targeting servo 447, a second targeting servo 449, an actuation valve 431, a sensor grid 441, a 120 v AC power source 460, a battery 461, a power converter 465, an LED bank 470, an audio alarm 471, a modem 480, a cellular module 481, a data port 482, a memory 483, a computing device 491, and a data cable 492.

The microcontroller 435 is in electronic communication with the first targeting servo 447, the second targeting servo 449, the LED bank 470, the actuation valve 431, the sensor grid 441, the audio alarm 471, the modem 480, the cellular module 481, the data port 482, and the memory 483. The power converter 465 is in electrical connection with the 120 v AC power source 460, the battery 461, the microcontroller 435, the first targeting servo 447, the second targeting servo 449, the LED bank 470, the audio alarm 471, and the actuation valve 431. The computing device 491 is in electrical communication with the data cable 492. The data cable 492 is in electrical communication with the data port 482.

In operation, the computing device 491 is electrically connected to the data port 482, of the microcontroller 435, using the data cable 492. The computing device 491 is used to enter values into the main operating loop and upload the main operating loop to the microcontroller 435. The microcontroller 435 stores the main operating loop in the internal memory. After the computing device 491 has completed uploading the main operating loop to the microcontroller 435, the computing device and the data cable are disconnected from the data port 482.

The 120 v AC power source 460 provides 120 v AC power to the power converter 465. The power converter 465 converts the 120 v AC to 12 v DC and 6 v DC. The power converter 465 supplies 12 v DC to charge the battery 461, in normal operation, and to the microcontroller 435, audio alarm 471, and actuation valve 431. The power converter supplies 6 v DC to the targeting servos 447, 449. If power is interrupted from the 120 v AC power source 460, the battery 461 supplies power to through the power converter 465.

The microcontroller 435 requests information from the sensor grid 441 at an interval of 0.5 seconds. The sensor grid 441 includes a plurality of thermistors, whose resistance representative of the temperature in the monitored area. The microcontroller 435 receives the resistance value from the sensor grid 441 and converts the voltage to a temperature value. When the microcontroller 435 senses a temperature above a predetermined active value, the microcontroller commences targeting. When the microcontroller 435 senses a temperature above the predetermined actuation value or a predetermined temperature rate, calculated each 10 second period, the microcontroller commences an extinguishing routine. In alternative embodiments the temperature rate calculation can be set to a higher or lower value, such as 0, 5, 20 or 60 seconds, depending on the size and environment of the room to be monitored.

When the system is in monitor mode the servo motors are kept at home position, or middle of the gimbal armature rotation travel, with the emitter 145 pointed straight down in the preferred embodiment, no targeting signals are sent from the microcontroller 435 to the targeting servos 447, 448. In alternative embodiments targeting signals are applied to maintain the emitter 145 pointed down. The microcontroller 435 shifts to active mode when at least one sensor, in the sensor grid 441 exceeds the predetermined active value. The microcontroller 435 is programmed with the grid position of each sensor, in the sensor grid 441. The microcontroller weights the temperatures of the sensors giving priority to sensors with the highest temperature above a reference value. The microcontroller 435 uses the weighted percent per sensor to determine the elevated heat position and corresponding targeting angles, by multiplying the weighted percent of the thermistor to the known sensor positions. The microcontroller 435 determines a final targeting angle on an x and y axis centered on the extinguishing system, representing the location of the fire, or elevated heat position Each target angle is sent to the targeting portion of the microcontroller 435. The microcontroller 435 determines a control signal to a desired armature position corresponding to the targeting angle, and sends the control signal or target angle data to the targeting servos 447, 449. The targeting servos 446, 448 move the targeting armatures 346, 348 to the received target angle data, positioning the emitter 345 to the elevated heat position. The microcontroller 435 receives actual armature position from the targeting servos 447 449 by sampling a feedback loop.

When the microcontroller 435 receives position angles equal to the targeting angles from the feedback loop of targeting servos 447, 449, the microcontroller sends an open signal to the actuation portion of the microcontroller 435. The microcontroller 435 sends an open signal to the actuation valve 431 to open to emit extinguishing agent.

To prevent continuous targeting and hunting, the microcontroller 435 is programmed with an activation value and dead zone. When the microcontroller 435 determines that no thermistor exceeds a predetermined activation value, such as 90° F., no commands, or signals to maintain position are sent from the microcontroller to the targeting servos 447, 449. When the microcontroller 435 is in active mode, the microcontroller will calculate the targeting angles each 0.5 second loop. If both targeting angle change by greater or equal to 5% the microcontroller 435 will send updated targeting angles to the targeting servos 447, 449, without disrupting the open signal to the actuation valve 431.

The microcontroller 435 sends signals to the LED bank 470 to indicate system status. The LED bank 470 has a plurality of LEDs indicating a function or status of the system. In one embodiment when the control circuit 135 is energized the microcontroller 435 sends a signal to energize a “system power” LED in the LED bank 470. When the microcontroller 435 sends an open “actuation” signal to the actuation valve 431, the micro controller sends a signal to deenergize a “ready” LED, and sends a signal to energize an “alert” LED in the LED bank 470. Each program loop the microcontroller momentarily energizes an interrupt service routine (“ISR”) LED in the LED bank 470. Depending on the functions equipped and the requirements for monitoring LEDs are added or removed to the LED bank 470 and the microcontroller programmed to illuminate as necessary.

In the preferred embodiment the main operating loop, beginning with the request of information from the sensor grid 441 is 0.5 seconds. In alternatives embodiments the main operating loop time is set to meet the specific conditions of the monitored area, such as 0.1, 25, 0.5, or 1 seconds.

In the preferred embodiment the targeting dead band is 5% change in either the first or second targeting angle. In rooms with smaller or larger dimensions the dead band is set to lower or higher values such as, 1 or 10% to increase target vector accuracy.

In an alternative embodiment, the sensor grid 441 is equipped with thermocouples for higher temperature application or actuation points. The thermocouples operate in the same way as the thermistors, but have a reliable temperature range higher than a thermistor.

In an alternative embodiment, the sensor grid 441 is equipped with photo-electric sensors. The photo-electric sensors detect light from a fire, in an unlit room, or from a bright fire in a lit room. The microcontroller 435 will sample the photo-electric sensors at the same 0.5 second interval. During an extinguishing routine if the microcontroller 435 determines that greater than a predetermined number of photo-electric sensors do not detect light above a predetermine level; the photo-electric sensors will be included in the weighted target angle calculation. After the initial actuation of the system, the microcontroller 435 removes the photo-electric sensor data from the target vector angle calculation, due to smoke inhibiting the reliability of the sensor. If during an extinguishng routine, the microcontroller 435 determines that greater than a predetermined number of the photo-electric sensors detect light, the photo-electric sensor data is not used for calculation, assuming that the room is lit and therefore, light data is not reliable. In an alternative embodiment, the photo-electric sensor data continues to be used with a threshold limit, such as 10% higher than other sensors.

In an alternative embodiment, the sensor grid 441 is equipped with ionization chamber or chambers. The ionization chamber of the sensor grid 441, detects the presence of smoke in the monitored space. The microcontroller 435 samples the ionization chamber at the same 0.5 second interval. If the microcontroller 435 determines that the ionization chamber detects the presence of smoke, the microcontroller lowers the actuation temperature value and rate. The lower actuation temperature value and rate allow for extinguishing routine to be performed sooner without increasing the risk of inadvertent discharge. If the sensor grid 441 is equipped with multiple ionization chambers, the target angle calculation is modified to incorporate the smoke data. The microcontroller 435 assigns a higher weight to areas with smoke, until a predetermined number of ionization chambers detect smoke. When the predetermined number of ionization chambers detect smoke the data from the ionization chamber will be removed from the calculation, because it no longer be strongly correlated with the fire location.

In an alternative embodiment, the sensor grid 441 includes an infrared or thermal imaging camera. The infrared camera sends higher accuracy temperature data to the microcontroller 435. The inferred camera is calibrated with the targeting circuit 243 to provide accurate targeting angels from a single camera or cross checked targeting angles from multiple cameras. If multiple infrared cameras are equipped the microprocessor 435 will equally weight the target location data of each camera that has detected an actuation temperature or rate.

In an alternative embodiment, the sensor grid 441 includes digital temperature detectors. The digital temperature detectors operate in the same way as the thermistors but would send a digital signal to the microcontroller 435, eliminating the need to convert the analog voltage supplied by a thermistor to a digital signal.

In an alternative embodiment, the system includes a modem 480 or cellular module 481, a data port 482, and a memory unit 483. The microcontroller is in data connection with the modem 480 or cellular module 481, the memory unit 483, and the data port 482. The modem is in data communication with a phone line. A computing device is connected to the data port 482.

In operation, the computing device sends alert data to the micro controller 435. The microcontroller 435 stores the alert information in the memory unit 483. The alert data includes a phone number and emergency message including the address of the system. The emergency message may be either text, voice, or other announcement or notification. The phone number may be a public or private emergency number. When the microcontroller 435 senses a temperature exceeding the predetermined actuation temperature value of temperature rate value, the microcontroller retrieves the alert data from the memory unit 483. The microcontroller sends the phone number portion of the alert data to the modem 480 or cellular module 481. When the modem 480 or cellular module 481 establishes a connection with a receiver through the phone line, the modem sends a communication established signal to the microcontroller 435. In response to the communication established signal, the microcontroller 435 sends the emergency message to the modem 480 or cellular module 481. The modem 480 or cellular module 481 transmits the emergency message to the receiver through the phone line to the receiving party. If the alert data includes multiple numbers, such as emergency service and owner, the microcontroller will execute the alert transmissions in the order that the numbers are programmed, until all emergency messages have been delivered.

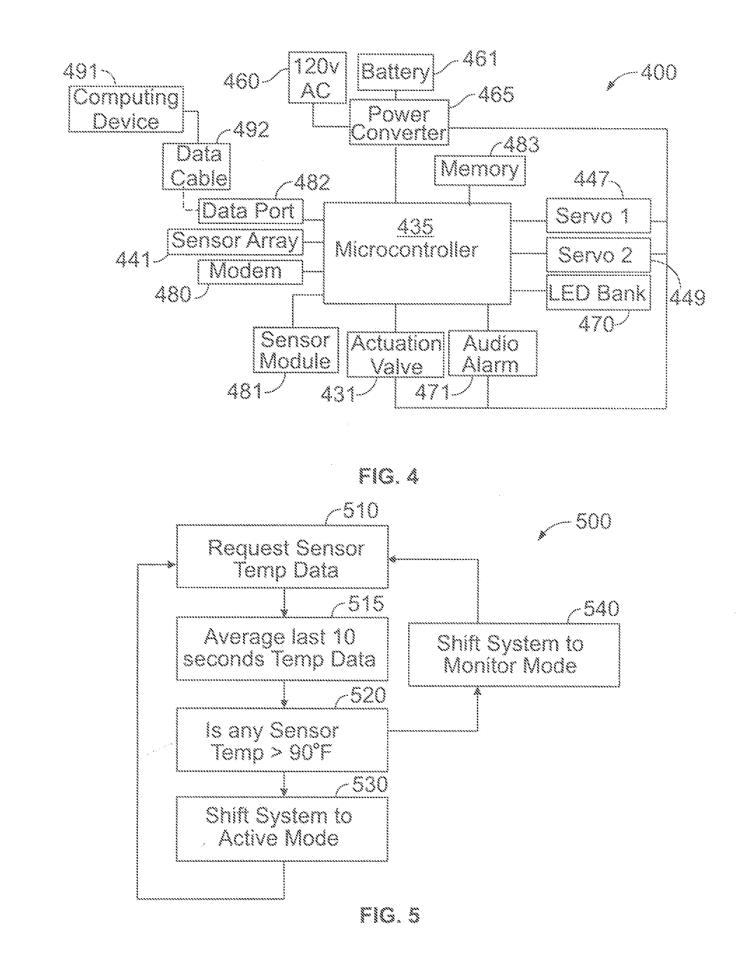

FIG. 5 illustrates a flow chart of the monitoring routine 500 according to an embodiment of the present invention.

First, at step 510 sensor temperature data is requested by the microcontroller. The microcontroller 435 requests temperature data form each of the sensors in the sensor grid 441. Next at step 515, the microcontroller 435 averages the last 10 seconds of temperature data of each sensor in response to receiving the temperature data from the sensor grid 441. The microcontroller 435 writes the temperature data to memory and deletes the oldest reading. The averaging of the last 10 seconds of temperature data 515 prevents microcontroller actions based on electrical noise. The temperature data averaging time, in 10 seconds in the preferred embodiment, but is changed to a higher or lower valve, such as 0, 1, 5, 20, or 60 seconds depending on the detectors used and the environment, to account for the relative noise detected by the sensors. Next at step 520, the microcontroller 435 compares the average sensor temperature to a predetermined value. The predetermined value is set high enough to prevent the system from entering active mode when no fire conditions exist. This prevents wear on the system components and conserves energy, preventing continuous targeting and hunting. In the preferred embodiment, the predetermine value is 90° F. The predetermined value is set to a higher or lower value to accommodate the environment of the space to be monitored, for example 85, 100, 110, or 200° F. If the temperature data for one or more sensors is greater than the predetermined value, the microcontroller 435 shifts to active mode 530. If the temperature data from all sensors is less than the predefined value the system shifts to monitor mode 510. The system completes this check every program cycle, after the system shifts to active mode 530 or shifts to monitor mode 540 the microcontroller 435 will recommence the process by requesting sensor temperature data at step 510.

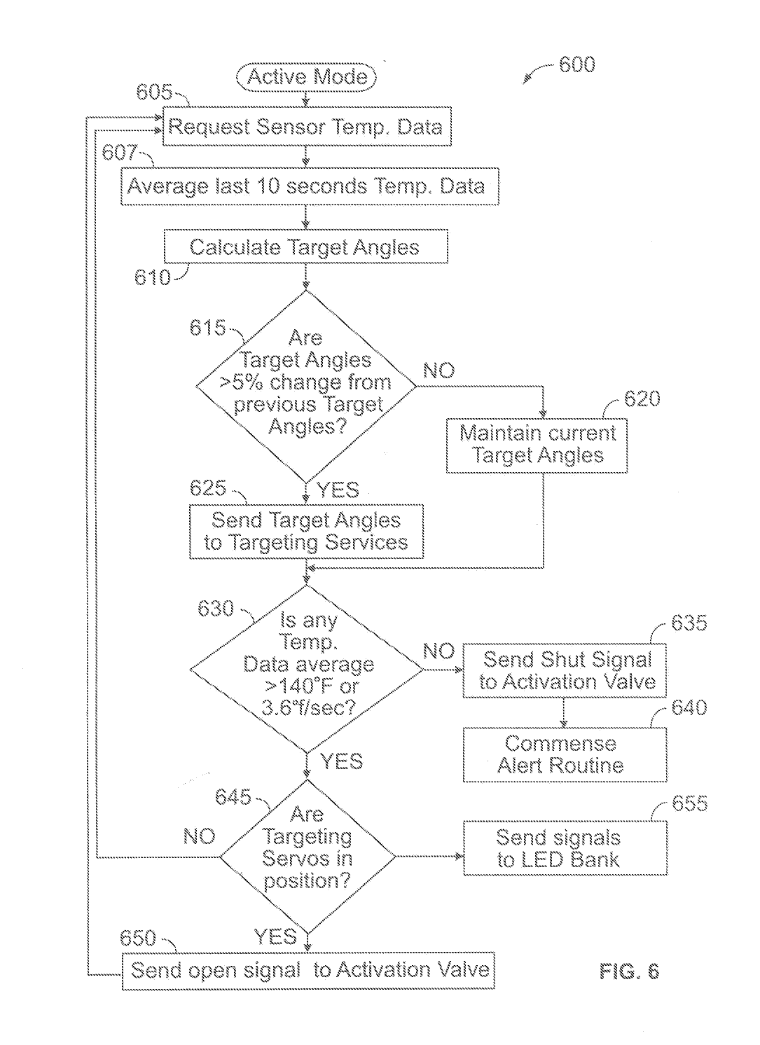

FIG. 6 illustrates a flowchart of the active mode 600 according to an embodiment of the present invention.

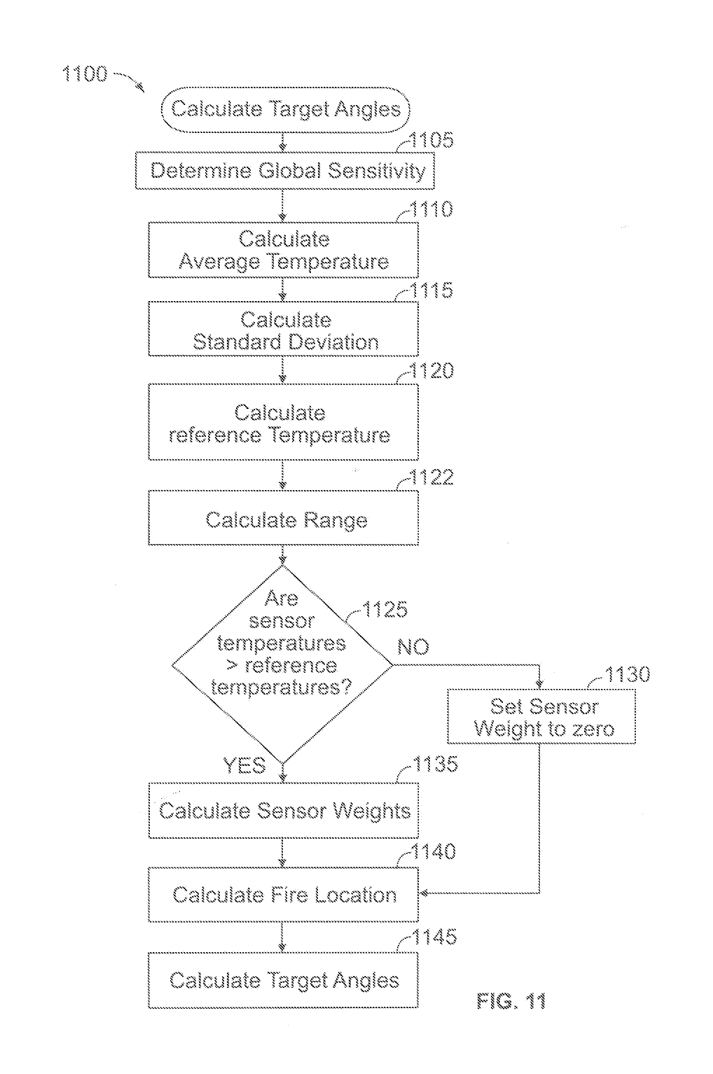

First at step 605, the microcontroller 435 requests sensor temperature data 605, from each sensor in the sensor grid 441. Next, at step 607 the microcontroller 435 averages the last 10 seconds of temperature data for each sensor, in response to receiving the sensor temperature data, the microcontroller retrieves the last 9 seconds of temperature data stored in memory. Next at step 610, the microcontroller 435 calculates targeting angles. The elevated heat position is determined by weighting the known location of the temperature sensors in the grid by the temperature data, then converting the elevated heat position to an targeting angles on an x and y axis, illustrated in FIG. 11. Next in step 615, the microcontroller 435 performs a comparison of the current target angle to the previous target angle. If either targeting angle is greater than a predetermine percent difference, such as 5%, from the previous targeting angle, the microcontroller 435 performs step 625, send the targeting angle data to the targeting servos 447, 449. If the current targeting angles are less than the predetermined percent difference from the previous targeting angle, the microcontroller 435 performs step 620, send the previous targeting angle data to the targeting servos 447, 449. After step 625, sending the targeting angle data or step 620, maintaining the targeting angle data, in step 630, the microcontroller 435 performs a comparison of the average sensor temperature data to the predetermined temperature value and rate value. The microcontroller 435 will compare each of the average sensor temperature to the predetermined actuation value and temperature change rate value. If no sensor temperature exceeds the predetermined actuation value or rate value, the microcontroller 435 performs step 635, send a shut signal to the actuation valve. Next, the microcontroller 435 recommences the process at step 605 by requesting sensor temperature data.

If any of the sensor temperatures exceed the predetermine temperature value or rate value, the microcontroller 435 commences the alert routine 640, and performs step 645, a comparison of the targeting angles to the targeting servo positions 645. If the targeting angles and targeting servo positions do not match, the microcontroller recommences the process at step 605 by requesting sensor temperature data. This allows for an additional operating loop to be performed while the servos reposition. When the microcontroller 435 determines that the targeting angle data and the targeting servo positions match, the microcontroller performs step 650, sending an open signal to the actuation valve. In addition to sending the open signal to the actuation valve, the microcontroller performs step 655 sends signals to update the LED bank. The LED for “ready” is deenergized and the LED for “alert” is energized. After performing step 650, sending the open signal to the actuation valve, the microcontroller 435 recommences the process at step 605 by requesting sensor temperature data.

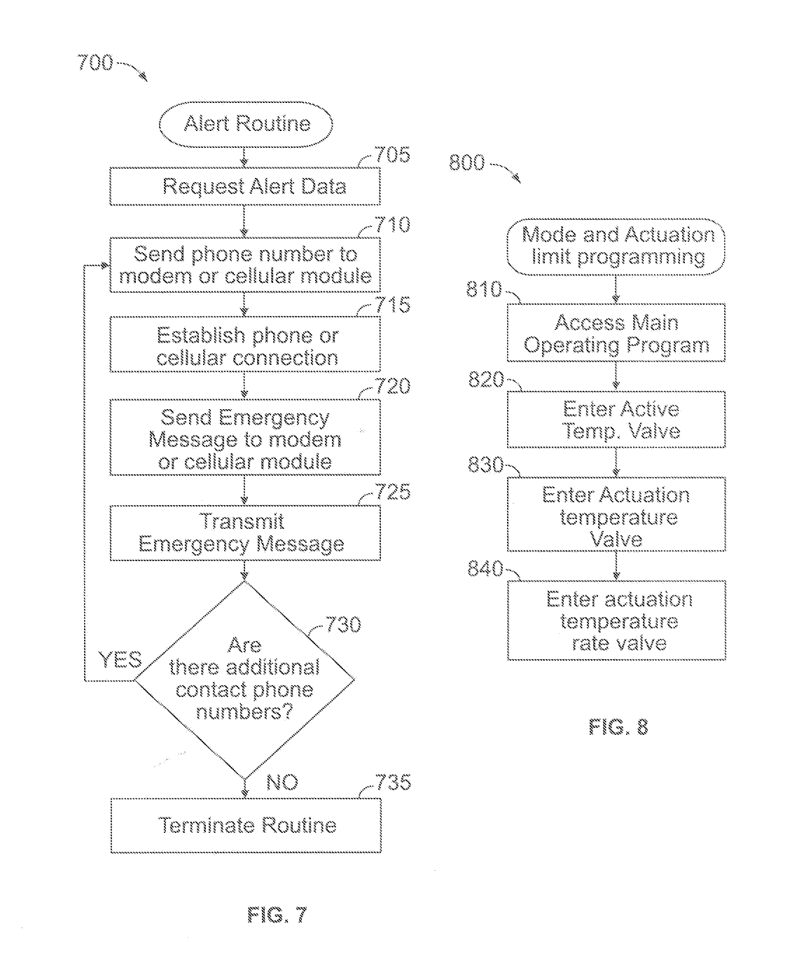

FIG. 7 illustrates a flow chart of the alert routine 700 according to an embodiment of the present invention.

First at step 705, the microcontroller 435 requests alert data from the memory unit 483. Next at step 710, the microcontroller 435 sends the first emergency phone number to the modem 480 or the cellular module 481, in response to receiving the alert data 705. Next at step 715, the modem 480 or cellular module 481 establishes a phone or cellular connection, in response to receiving the emergency phone number. Next at step 720 the microcontroller 435 sends the emergency message to the modem or cellular. The emergency message may be text information or audio information, usually the address of the unit the nature of the emergency, fire. Next at step 725 the modem or cellular module transmits the emergency message through the phone or cellular connection. After transmission of the emergency message 725, the microcontroller 435 will check the alert data for additional contact phone numbers at step 730. If there are additional contact phone numbers, the microcontroller 435 repeats the process by sending the additional phone number to the modem or cellular device 710. If there is not an additional phone number the microcontroller 435 terminates the routine at step 735.

FIG. 8 illustrates a flowchart of the mode and actuation programing 800 according to an embodiment of the present invention.

In operation, the mode and actuation limit programming 800, is completed on a computing device 491. First, at step 810, the computing device 491 accesses the main operating program. Next at step 820, the computing device 491 is used to enter an active temp value. The active temp value is the temperature that the microcontroller 435 shifts the system to active mode. Most homes temperatures are maintained at approximately 70-80° F. in the preferred embodiment the active temperature value is 90° F., high enough to ensure that the system is not wasting energy or wearing components by continuous targeting, but low enough to allow the system to begin targeting before the area reaches an actuation temperature. The active temperature value is set to a lower or higher value depending on the environment of the space to be protected, for example 85, 100, or 110° F. Next at step 830, the computing device 491 is used to enter an actuation temperature value. Typical home sprinkler systems activate between 135-190° F., in the preferred embodiment the actuation temperature value is 140° F. near the lower end of the band. The actuation temperature value is set to a higher or lower value depending on the environment of the space to be protected, for example 135, 150, or 190° F. Next at step 840, the computing device 491 is used to enter an actuation temperature rate. Rate rise thermal detectors are typically set for actuation at 12° F. over a minute, in the preferred embodiment the temperature rate value is 3.6° F. over 10 seconds, this accounts averaging temperatures over 10 seconds. The actuation temperature rate value is set to a higher or lower value depending on the environment of the space to be protected, for example 3, 4, or 5° F. over a second.

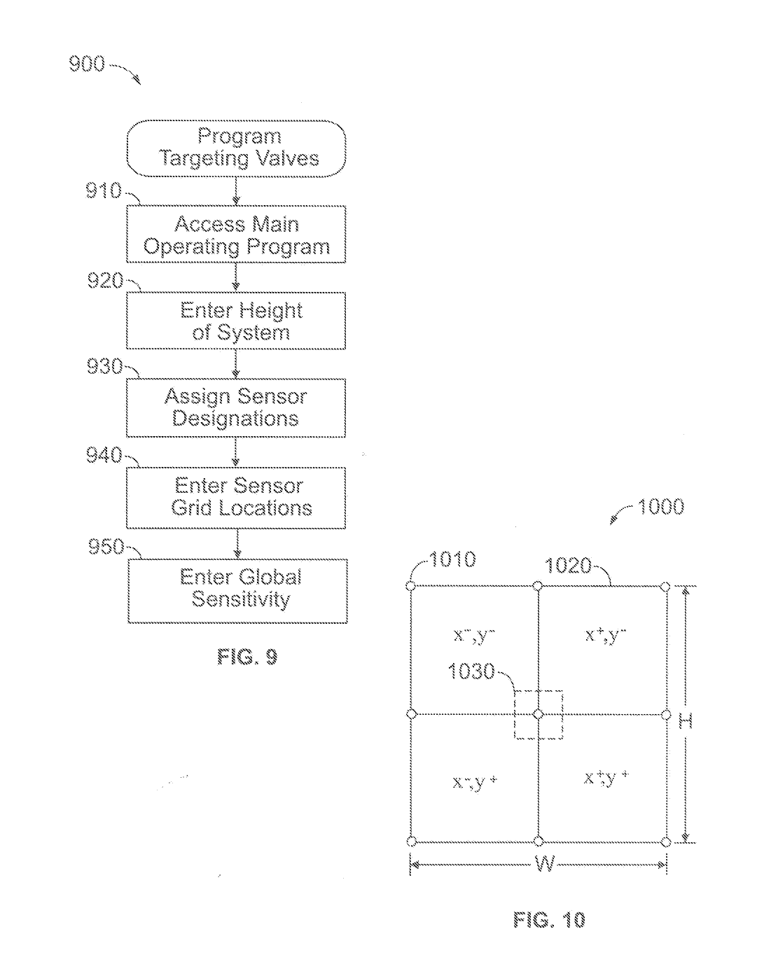

FIG. 9 illustrates a flowchart of programming targeting values 900 according to an embodiment of the present invention.

First at step 910, a computing device 491 is used to access the main operating program 910. Next at step 920, the computing device 491 is then used to enter the height of the system. The height of the system is determined by the physical position of the system in the room to be protected, for example 8 ft from the floor. Next at step 930, the computing device 491 is used to assign sensor designations. Each sensor in the sensor grid 441 is assigned a designation, this provides the main operating program with the total number of detectors and the sensor's reference nomenclature. In the preferred embodiment the sensors are designated A0, A1, A2 . . . . Next at step 940, the computing device 491 is used to enter sensor grid locations. Each sensor in the sensor grid 441 is assigned a grid location in distance from the emitter 245 on an x/y axis. For example 9 sensors placed in an 8 ft×8 ft room may be placed in at the following positions each value being the distance on the floor from the reference point of the emitter 245: 0,0 (directly below the emitter); −4,4; 0,4; 4,−4; 4,0; 4,4; 0,4; −4, −4; and −4,0. Each position corresponds to the farthest corners of the room, the walls and the emitter reference in feet. Next at step 950, the computing device 491 is used to enter a global sensitivity. The global sensitivity is a multiplication constant applied to allow the program to use temperature data greater than 1 standard deviation from the Temperature Reference in the targeting angle calculation.

FIG. 10 illustrates an overhead view of a sensor grid 1000 according to an embodiment of the present invention. The sensor grid includes a plurality of sensors 1010 a supporting structure 1020 and the extinguishing agent emission system 1030.

The sensors 1010, of the sensor grid 1000, are physically connected to the supporting structure 1020, and electrically connected to the extinguishing agent emission system 1030. The automatic fire targeting and extinguishing system 1030 is physically connected to the supporting structure 1020.

In operation, the supporting structure 1020 is a ceiling and support rafters or false ceiling and/or hanging attachments, for example, where the true ceiling is too high for effective discharge of the extinguishing agent. The automatic fire targeting and extinguishing system 1030 is preferably positioned as near the center of the area to be protected by the unit. The sensors 1010 are placed in a grid pattern connected to the supporting structure. In the preferred embodiment the sensors 1010 are supported by the ceiling tiles or sheet rock. Alternatively the sensors 1010 are suspended from the support structure 1020, where the true ceiling is too high for effective discharge of the extinguishing agent. As the heat from a fire rises, the sensors 1010 are most effective at the highest point of the room, but could be positioned at lower positions depending on the environment of the space to be protected. The sensors 1010 are electrically connected to the extinguishing agent emission system 1030.

The position of the emitter 245 from the floor is measured and entered as the height of the system 910 of the programming targeting values 900 as illustrated in FIG. 9. The position of each sensor 1010 is measured from the emitter reference position. For example the sensor at center with the emitter is given a value of 0,0. The sensor 1010 in an 8 ft by 8 ft room in the right bottom corner is given a value of 4, 4 corresponding to 4 ft right (or +x axis), 4 ft. down or (+y axis). The sensor 1010 at the right top of the room would be assigned a value of −4,−4, corresponding to 4 ft left (−x axis) and 4 ft. up or (−y axis). Each of the grid locations is entered as a sensor grid location 940, of programing targeting values 900.

In an alternative embodiment, the extinguishing agent emission system 1030 is positioned at a location other than the center of the room. This is desirable where other fixtures such as electrical lights are positioned in the center of the ceiling. The grid locations are determined by measuring the distance of each sensor 1010 form the emitter reference position.

In an alternative embodiment the area to be protected is larger than the effective discharge of the extinguishing agent emission system 1030, a plurality of extinguishing agent emission systems are installed. The sensor grid 1000 overlaps or has a common area by connecting the sensors 1010 to multiple units. For example in a 16×8×8 room 2 extinguishing agent emission systems 1030 of the preferred embodiment are necessary. The each extinguishing agent emission system 1030 is electrically connected to 9 sensors 1010. The 3 sensors at the shared edge of coverage are electrically connected to both extinguishing agent emission system, therefore only 15 sensors are used.

FIG. 11 illustrates the calculation of targeting angles 1100 according to an embodiment of the present invention.

In operation, the microcontroller 435 runs the main operating loop. The microcontroller 435 determines the global sensitivity 1105 from the stored value from the programing target values 900 (FIG. 9).

Global Sensitivity Factor=μ=0.3 Equation 1

The microcontroller 435 then calculates the average temperature 1110 by using the individual sensor 1110 temperatures.

$$Average = \overline{T} = \frac{1}{n} {\sum }_{i = 1}^{n} {T}_{i} = \frac{{T}_{i} + {T}_{2} + … + {T}_{n - 1} + {T}_{n}}{n} \qquad Equation 2$$

The microcontroller 435 uses the average temperature calculates the standard deviation 1110, from the average sensor temperature.

$$Std . Deviation = s = \sqrt{\frac{{\sum }_{i = 1}^{n} {( {T}_{i} - \overline{T} )}^{2}}{n - 1}} \qquad Equation 3$$

Following the calculation of standard deviation 1115, the microcontroller 435 calculates a reference temperature 1120 using the standard deviation, global sensitivity value and the average temperature.

Reference=Ref=T+s*μ

Following the calculation of the reference temperature 1120, the microcontroller 435 calculates a range 1110. The range is the highest temperature from the sensors 1110 minus the reference temperature. If the range is a value of less than 0.5° F. the microcontroller 435 sets the range value to 1.

Range(set to 1 if value less than 0.5)=Tₘₐₓ−Ref Equation 5

Following calculating the range 1122, the microcontroller 435 compares the individual sensor 1110 temperature to the reference temperature 1125. If the individual sensor 1110 temperature is less than the reference temperature the microcontroller 435 sets the sensor weight to zero 1130. If the individual sensor temp is greater than the reference temperature 1125, the micro controller calculates the sensor weight 1135. The microcontroller 435 calculates the sensor weight using the temperature detected by the sensor 1110 expressed TFI (Temperature Fahrenheit Individual), the reference temperature and the range.

$$PercentTempI = \frac{TFI - Ref}{Range} ( only if TFI > Ref , otherwise = 0 ) \qquad Equation 6$$

Following the calculating sensor weight 1135 or the setting sensor weight to zero 1130, the microcontroller 435 calculates the fire location 1140. First the microcontroller 435 calculates an output position for each sensor on the x and y axis, using the sensor weight and the entered grid locations.

OutPosAX=PercentTempA*SensPosAX

OutPosAY=PercentTempA*SensPosAY Equation 7

Next, the microcontroller adds the sensor weighs to determine a Sum Percent Temperature value.

SumPercentTemp=PercentTempA+ . . . +PercentTempI Equation 8

The microcontroller 435 then adds the output position for each sensor to determine an x axis Sum output and a y axis sum output.

SumXout=OutPosAX+OutPosBX+ . . . +OutPosIX

SumYout=OutPosAY+OutPosBY+ . . . +OutPosIY Equation 9

The microcontroller 435 then calculates the elevated heat position or fire location on an x and y axis, using the sum x axis or sum y axis output and the sum percent temperature value.

$${X}_{fire} = \frac{SumXout}{SumPercentTemp} , ( only if SumPercentTemp does not equal 0.0 ) \\ {Y}_{fire} = \frac{SumYout}{SumPercentTemp} , ( only if SumPercentTemp does not equal 0.0 ) \qquad Equation 10$$

After the microcontroller 435 has calculated the elevated heat position 1140, the micro controller calculates targeting angle data 1145. The microcontroller calculates a targeting angle for both the x and y axis, using the elevated heat position 1140, and the entered height of the system 920, or ceiling height.

$$angle α = {tan}^{- 1} ( \frac{{X}_{fire}}{Ceiling Height} ) * \frac{180 deg}{π} \to send to ServoAlpha \\ angle β = {tan}^{- 1} ( \frac{{Y}_{fire}}{Ceiling Height} ) * \frac{180 deg}{π} \to send to ServoBeta \qquad Equation 11$$

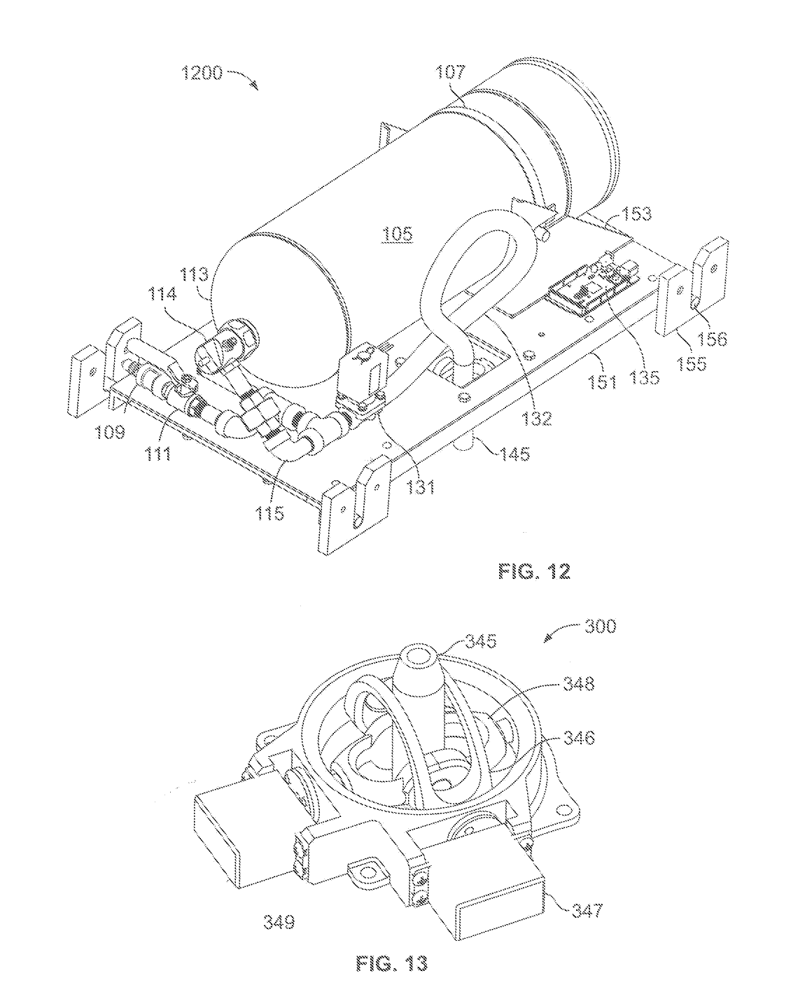

FIG. 12 illustrates an assembled view of an extinguishing agent emission system 1200. The extinguishing agent emission system 1200 is the same as extinguishing agent emission system 100 of FIG. 1, but assembled for context.

FIG. 13 illustrates an exploded view of a targeting gimbal 1300. The targeting gimbal 1300 is the same as the targeting gimbal 300 of FIG. 3, but assembled for context.

In the some embodiments of the prior art the extinguishing device required a user to be in close proximity with the fire to effectively discharge the extinguishing agent. The automatic fire targeting and extinguishing system is redundantly automatic. In normal operation the system locates, targets, and discharges extinguishing agent onto the fire. In backup mode the system utilizes a sprinkler head to discharge the extinguishing agent onto the area. Both modes operate automatically without a user, maximizing the safety of personnel.

In some embodiments of the prior art the extinguishing system discharged nearly unlimited amounts of extinguishing agent causing unnecessary damage to unaffected areas and flooding. These systems further failed to utilize a targeting system. To ensure that a fire was effectively extinguished the system relies on continually discharging until a user shuts off the supply. The automatic fire targeting and extinguishing system has a limited capacity and targeting system. The utilization of the targeting system allows the automatic fire targeting and extinguishing system to discharge a small amount of extinguishing agent directly at the fire. This minimizes the damage to unaffected areas and limits the amount of extinguishing agent required to effectively extinguish the fire.

In some embodiments of the prior art the extinguishing system used clean agents to displace the oxygen to smother the fire. The use of clean agents prevents damage to valuable equipment and unaffected areas, but endangers any personnel that are present either during or after the discharge. The automatic fire targeting and extinguishing system does not require the use of clean agents to maximize the effect extinguishing of the fire while minimizing the damage to property. Therefore does not have inherent risk to personnel.

In some embodiments of the prior art the extinguishing system was configured for infrared detection only, limiting the possible applications and targeting inputs. The automatic fire targeting and extinguishing system is be configured to use temperature detectors, infrared sensors, ion chambers, and thermal imaging to maximize the effectiveness of the targeting system and extinguishing routines.

In some embodiments of the prior art the extinguishing system utilized a targeting system with complex motor and gear combinations to position discharge emitters and armatures. The automatic targeting system uses a simple gimbal targeting system with servos directly mounted to the armatures. This reduces the moving components of the targeting system and increases reliability. Further, the direct attachment of the servo to the armatures and armatures to emitter reduces travel distances, reducing the time necessary to position the emitter for discharge.

In some embodiments of the prior art used a single sensor for determining a fire location. This unnecessarily limits the coverage area and accuracy. The automatic fire targeting and extinguishing system employs a plurality of sensors arranged in a grid pattern. The use of multiple sensors and the grid pattern maximizes the coverage area of the area to be protected and increases the accuracy of the extinguishing agent, because the system will have more and more accurate targeting information.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

What we claim is:

1. A fire targeting and extinguishing system including:
a directional temperature sensor system, wherein the directional temperature sensor system includes a plurality of sensors configured in a grid pattern; wherein the sensor are used to determine an elevated heat position; and
an extinguishing agent emission system, which receives the elevated heat position and positions an extinguishing agent emitter to emit extinguishing agent toward the elevated heat position.

2. The fire targeting and extinguishing system of claim 1, wherein the extinguishing agent emission system further includes an actuation valve;
wherein the actuation valve opens to emit extinguishing agent in response to a sensor detecting a temperature above a predetermined temperature value.

3. The fire targeting and extinguishing system of claim 2, wherein the actuation valve opens to emit extinguishing agent in response to a sensor detecting a temperature rate above a predetermined temperature rate value.

4. The fire targeting and extinguishing system of claim 1, wherein the fire extinguishing agent is chosen from the group: water, carbon dioxide, aqueous film forming foam, monoammonium phosphate, and Purple-K.

5. The fire targeting and extinguishing system of claim 1, wherein the plurality of sensors is chosen form the group: thermistors, thermocouples, and infrared sensors.

6. The fire targeting and extinguishing system of claim 1, wherein the extinguishing agent emission system positions the extinguishing agent emitter in response to a sensor detecting a temperature above a predetermined active value.

7. The fire targeting and extinguishing system of claim 1, further including a communication module, wherein the communication device sends emergency data to a receiver in response to sensor detecting a temperature above a predetermined temperature value.

8. The fire targeting and extinguishing system of claim 1, further including a communication module, wherein the communication module sends emergency data to a receiver in response to sensor detecting a temperature rate above a predetermined temperature rate value.

9. The fire targeting and extinguishing system of claim 1, further including a smoke detector, wherein the extinguishing agent emission system emits extinguishing agent in response to detecting smoke.

10. The fire targeting and extinguishing system of claim 2, further including an audio alarm, wherein the audio alarm is activated in response to opening the actuation valve.

11. The fire targeting and extinguishing system of claim 1, wherein the extinguishing agent is continuously pressurized.

12. The fire extinguishing system of claim 1, wherein the actuation valve shuts in response to all of the sensors detecting temperatures less than the predetermined temperature value.

13. A gimbal positioning system including;
a targeting gimbal including a first targeting armature and a second targeting armature, wherein the first and second targeting armatures are independently connected to a gimbal base;
a first targeting servo and a second targeting servo, wherein the first targeting servo is physically connected to the first targeting armature and gimbal base, and the second targeting servo is physically connected to the second targeting armature and gimbal base, wherein the first and second targeting servos are electrically connected to a microcontroller;
an emitter, wherein the emitter is in physical connection with the first and second targeting armature;
wherein the microcontroller sends a target angle data to the first and second targeting servos, wherein in response to receiving the target angle data, the first and second targeting servos position the first and second targeting armatures; and
wherein the emitter emits an agent in response to the microcontroller positioning the first and second targeting armatures.

14. A method of targeting a fire the method including:
receiving a sensor temperature data from a plurality of temperature sensors at a microcontroller, wherein the temperature sensors are arranged in a grid pattern;
retrieving stored sensor location data on a microcontroller;
calculating at the microcontroller an elevated heat position; wherein the elevated heat position is calculated using the sensor temperature data and sensor location data;
Calculating at the microcontroller a first and second targeting angle data; wherein the targeting angle data corresponds to the elevated heat position;
sending a first target angle data to a first targeting servo and a second target angle data to a second targeting servo,
positioning an emitter; wherein positioning the emitter includes the first targeting servo positioning a first gimbal armature to the first target angle data and the second targeting servo positioning a second targeting gimbal armature to the second target angle data, wherein the positioning of the first and second gimbal armature physically positions the emitter to emit in the direction of the elevated heat position.

15. The method of targeting a fire of claim 14, further including;
comparing the sensor temperature data to a predetermined temperature value;
sending an open signal to an actuation valve in response to a sensor temperature data in excess of the predetermined temperature value; and
emitting an extinguishing agent through the actuation value and emitter onto a fire.

16. The method of targeting a fire of claim 14, further including;
comparing the sensor temperature data to a predetermined temperature rate value;
sending an open signal to an actuation valve in response to a sensor temperature data in excess of the predetermined temperature rate value; and
emitting an extinguishing agent through the actuation value and emitter onto a fire.

17. The method of targeting a fire of claim 14, further including;
retrieving a stored emergency message on the microcontroller, in response to a temperature value exceeding the predefined temperature value;
establishing communication with a receiver; and
transmitting the emergency message.

18. The method of targeting a fire of claim 14, wherein calculating elevated heat position further includes:
receiving sensor temperature data;
calculating the average sensor temperature;
calculating a standard deviation from the sensor temperature data;
calculating a reference temperature; wherein the calculating a reference temperature adds the average temperature and the standard deviation;
calculating a range for each of the sensor temperature data, wherein calculating a range includes subtracting the reference temperature form the sensor temperature data;
calculating sensor weights; wherein the calculating of sensor weight is the sensor temperature data minus the reference temperature divided by the range, wherein if the sensor temperature data is less than the reference temperature the weight is zero;
calculating elevated heat position, wherein the calculating elevated heat position is the product of the sensor weight and sensor locations on and x axis and y axis;
calculating target angles, wherein the calculating target angles is triganomic function of the elevated heat position on an x axis and y axis, and a system height.

19. The method of targeting a fire of claim 18, further including:
determining a global sensitivity, wherein the global sensitivity stored on the microcontroller;
wherein the calculating a reference temperature further includes multiplying the standard deviation by the global sensitivity prior to adding the average temperature.
